(19) United States
(12) Patent Application Publication
(10) Pub. No.: US 2025/0236199 A1
(43) Pub. Date: Jul. 24, 2025

(54) MANAGEMENT SYSTEM

(71) Applicant: TOYOTA JIDOSHA KABUSHIKI KAISHA, Toyota-shi (JP)

(72) Inventors: Tomoya TAKAHASHI, Ebina-shi (JP); Shunsuke KOBUNA, Mishima-shi (JP)

(73) Assignee: TOYOTA JIDOSHA KABUSHIKI KAISHA, Toyota-shi (JP)

(21) Appl. No.: 18/919,450

(22) Filed: Oct. 18, 2024

(30) Foreign Application Priority Data
Jan. 19, 2024 (JP) 2024-006697

(51) Int. Cl. B60L 53/62; B60L 53/68; B60L 58/12

(52) U.S. Cl. CPC B60L 53/62; B60L 53/68; B60L 58/12

(57) ABSTRACT

A management system includes a first management device that manages a vehicle group including a plurality of electrified vehicle, and a second management device that requests the first management device for energy management related to the power system PG. The first management device determines whether there is an electrified vehicle present within the vehicle group that requires immediate charging, when determination is made that there is an electrified vehicle present within the vehicle group that requires immediate charging, on an assumption that the electrified vehicle performs immediate charging, the first management device is configured to acquire information that shows a chargeable and dischargeable amount including at least one of a power amount that enables the vehicle group to be charged and a power amount that enables the vehicle group to be discharged, and transmit information that shows the acquired chargeable and dischargeable amount to the second management device.

### CROSS-REFERENCE TO RELATED APPLICATION

This application claims priority to Japanese Patent Application No. 2024-006697 filed on Jan. 19, 2024, incorporated herein by reference in its entirety.

### BACKGROUND

### 1. Technical Field

The present disclosure relates to a management system for energy management.

### 2. Description of Related Art

Japanese Unexamined Patent Application Publication No. 2012-060834 (JP 2012-060834 A) discloses technology, when a plurality of electrified vehicles is charged, that uses power discharged from an electrified vehicle, for which completion of charging is expected first, for charging of the other electrified vehicles. The plurality of electrified vehicles is, for example, battery electric vehicles.

### SUMMARY

A management system is known that includes a first management device that manages a vehicle group including a plurality of electrified vehicles, and a second management device that requests energy management related to a power system to the first management device. In the management system, for example, the first management device calculates a chargeable and dischargeable amount of the vehicle group in a prescribed time period in the future and transmits the calculated chargeable and dischargeable amount to the second management device. In addition, the second management device determines the energy management requested to the first management device in the prescribed time period, based on the chargeable and dischargeable amount of the vehicle group received from the first management device. However, when charging that the first management device did not predict is executed in the prescribed time period, in accordance with a user's request, there is a possibility that a deviation occurs between the chargeable and dischargeable amount of the vehicle group transmitted by the first management device and an actual chargeable and dischargeable amount of the vehicle group.

There is a possibility that the deviation hinders execution of the energy management requested in accordance with the chargeable and dischargeable amount of the vehicle group transmitted by the first management device. For example, when an actual chargeable and dischargeable amount of the vehicle group is smaller than a value transmitted by the first management device, execution of the requested energy management becomes difficult. Accordingly, it is conceivable to offset the deviation, by power transfer between electrified vehicles included in the vehicle group (for example, refer to JP 2012-060834 A). However, in the power exchange between electrified vehicles, a loss occurs along with charging/discharging. In order to reduce the loss, it is desirable to eliminate the need for power transfer between electrified vehicles. Namely, it is desirable to reduce the possibility of charging that the first management device did not predict being executed, after the first management device transmits the chargeable and dischargeable amount of the vehicle group.

The present disclosure can solve the problem. According to the present disclosure, the possibility of charging that a first management device did not predict being executed, after the first management device transmits information that shows a chargeable and dischargeable amount of a vehicle group to a second management device, can be reduced.

A management system relating to one aspect of the present disclosure includes a first management device that manages a vehicle group including a plurality of electrified vehicles, and a second management device that requests energy management related to a power system to the first management device.

Each of the plurality of electrified vehicles included in the vehicle group includes a power storage device and is configured to enable the power storage device to be charged by power from the power system.
The first management device determines whether there is an electrified vehicle present within the vehicle group that requires immediate charging, when determination is made that there is an electrified vehicle present within the vehicle group that requires immediate charging, on an assumption that the electrified vehicle performs immediate charging, the first management device is configured to acquire information that shows a chargeable and dischargeable amount including at least one of a power amount that enables the vehicle group to be charged and a power amount that enables the vehicle group to be discharged, and transmit information that shows the acquired chargeable and dischargeable amount to the second management device.
The immediate charging is charging that, when any one of the electrified vehicles included in the vehicle group is electrically connected to the power system, the electrified vehicle immediately starts by using power from the power system.

According to the present disclosure, it becomes possible to reduce the possibility of charging that a first management device did not predict being executed, after the first management device transmits information that shows a chargeable and dischargeable amount of a vehicle group to a second management device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a management system according to an embodiment of the present disclosure;

FIG. 2 is a diagram for describing a processing flow in which the first management device acquires and transmits information indicating a chargeable and dischargeable amount in the management system shown in FIG. 1;

FIG. 3 is a diagram for explaining an example of information indicating a chargeable and dischargeable amount;

FIG. 4 is a diagram for describing energy management executed by a management system according to an embodiment of the present disclosure;

FIG. 5 is a diagram for describing an exemplary charge/discharge control according to the present embodiment; and

FIG. 6 is a diagram for explaining power transfer between electrified vehicle included in a vehicle group.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

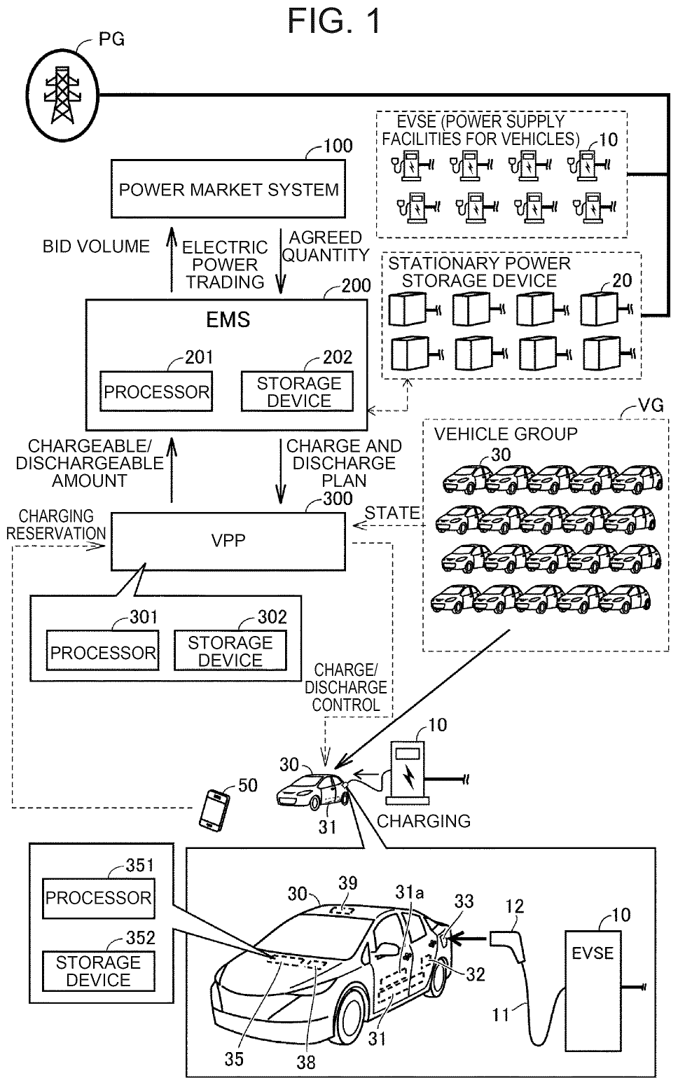

FIG. 1 is a diagram illustrating an outline of a power system and a management system according to an embodiment of the present disclosure. Referring to FIG. 1, a power system includes a power system PG, a plurality of Electric Vehicle Supply Equipment (EVSE: power supply facilities for vehicles) 10, and a plurality of power storage devices 20. The power system PG is a power grid constructed by a transmission and distribution facility. The power system PG may include a substation. The power system PG may be connected to a power generation facility (not shown). Each of the plurality of EVSE 10 and the plurality of power storage devices 20 is electrically connected to the power system PG. In this embodiment, EVSE 10 is an AC power supply facility for outputting AC power. However, the present disclosure is not limited thereto, and EVSE 10 may be a DC power supply facility for outputting DC power. EVSE 10 may be a charger installed (fixed) in a house or a public charging station. The power storage device 20 is a stationary power storage device. The power storage device 20 may be a commercial Energy Storage System (ESS) or a power storage device installed (fixed) in a house.

The management system includes a power marketplace system 100, an Energy Management System (EMS) 200, and a Virtual Power Plant (VPP) system 300.

VPP system 300 manages a vehicle group VG including a plurality of electrified vehicles 30. Each of the plurality of electrified vehicles 30 included in the vehicle group VG includes a power storage device 31, and is configured to be able to charge the power storage device 31 by electric power from the power system PG. The power storage device 31 corresponds to an in-vehicle battery. Electrified vehicle 30 is configured to be able to travel using electric power outputted from the power storage device 31. Electrified vehicle 30 further includes a driving device (for example, one or more motors not shown) that rotates the driving wheels of electrified vehicle 30 by using the electric power from the power storage device 31. Electrified vehicle 30 may be a battery electric vehicle (BEV) without an internal combustion engine. Electrified vehicle 30 may be a plug-in hybrid electric vehicle (PHEV) including an internal combustion engine. FIG. 1 illustrates an exemplary configuration of an electrified vehicle 30.

Electrified vehicle 30 includes, in addition to the power storage device 31, a charge/discharge circuit 32 (in-vehicle charge/discharge device) and an inlet 33 (power receiving port). Electrified vehicle 30 further comprises an Electronic Control Unit (ECU) 35, a Human Machine Interface (HMI) 38, and a communication device 39. ECU 35 includes a processor 351 and a storage device 352. The power storage device 31 is provided with a Battery Management System (BMS) 31a for monitoring the status of the power storage device 31. BMS 31a includes various sensors for detecting the status of the power storage device 31, and outputs the detected data to ECU 35. BMS 31a detects, for example, the temperature, current, voltage, and State of Charge (SOC) of the power storage device 31. SOC indicates the amount of stored electricity, and represents, for example, the ratio of the present amount of stored electricity to the amount of stored electricity in a fully charged state from 0 to 100%.

A distal end portion (connector 12) of the charging cable 11 connected to EVSE 10 is connected to an inlet 33 of the parking electrified vehicle 30 (plug-in). Then, electrified vehicle 30 is electrically connected to EVSE 10 (and thus the power system PG). Hereinafter, a state in which electrified vehicle 30 and the power system PG are electrically connected to each other is referred to as a “system connected state”. A state in which electrified vehicle 30 and the power system PG are not electrically connected to each other is referred to as a “system disconnection state”.

The charge/discharge circuit 32 includes a power conversion circuit (for example, a bidirectional inverter). In the grid connected state electrified vehicle 30, external charging (charging of the power storage device 31 by electric power from the outside of the vehicle) and external power feeding (power feeding to the outside of the vehicle by electric power from the power storage device 31) are enabled. Electrified vehicle 30 can manage the power system PG by external charge and external power supply. The electric power for external charge is supplied from the power system PG to the inlet 33 through EVSE 10, for example. The charge/discharge circuit 32 converts the electric power received by the inlet 33 into electric power (for example, DC electric power) suitable for charging the power storage device 31, and outputs the converted electric power to the power storage device 31. Power for external power supply is supplied from the power storage device 31 to the charge/discharge circuit 32. The charge/discharge circuit 32 converts the DC power supplied from the power storage device 31 into electric power suitable for external power supply (for example, AC power), and outputs the converted electric power to the inlet 33. In the following explanation, the charge, discharge, and storage amounts of electrified vehicle 30 refer to the charge, discharge, and storage amount of the power storage device 31, respectively.

HMI 38 includes an inputting device and a displaying device. HMI 38 includes, for example, a navigation system (hereinafter, referred to as “navigation”). The navigation system detects the position of electrified vehicle 30 by using a positioning system such as a Global Positioning System (GPS), for example. When the user sets the destination in the navigation, the navigation displays the travel route to the destination to the user. ECU 35 wirelessly communicates with VPP system 300 through the communication device 39. VPP system 300 can control charging and discharging of the grid connected state electrified vehicle 30 from a remote location.

The mobile terminal 50 is carried by a user of electrified vehicle 30. The mobile terminal 50 is, for example, a smartphone including a touch panel display. Application software for using VPP system 300 is installed in the mobile terminal 50. The mobile terminal 50 receives a charging reservation from the user. By inputting the scheduled departure time and the target SOC at that time to the mobile terminal 50, the user can reserve (require) VPP system 300 to charge SOC of the power storage device 31 to be equal to or higher than the target SOC by the scheduled departure time. The mobile terminal 50 transmits information related to the reserved charging (hereinafter, referred to as “charging reservation information”) to VPP system 300 together with the identification information of the corresponding electrified vehicle 30. The charge reservation data includes the scheduled departure time and the target SOC entered by the user.

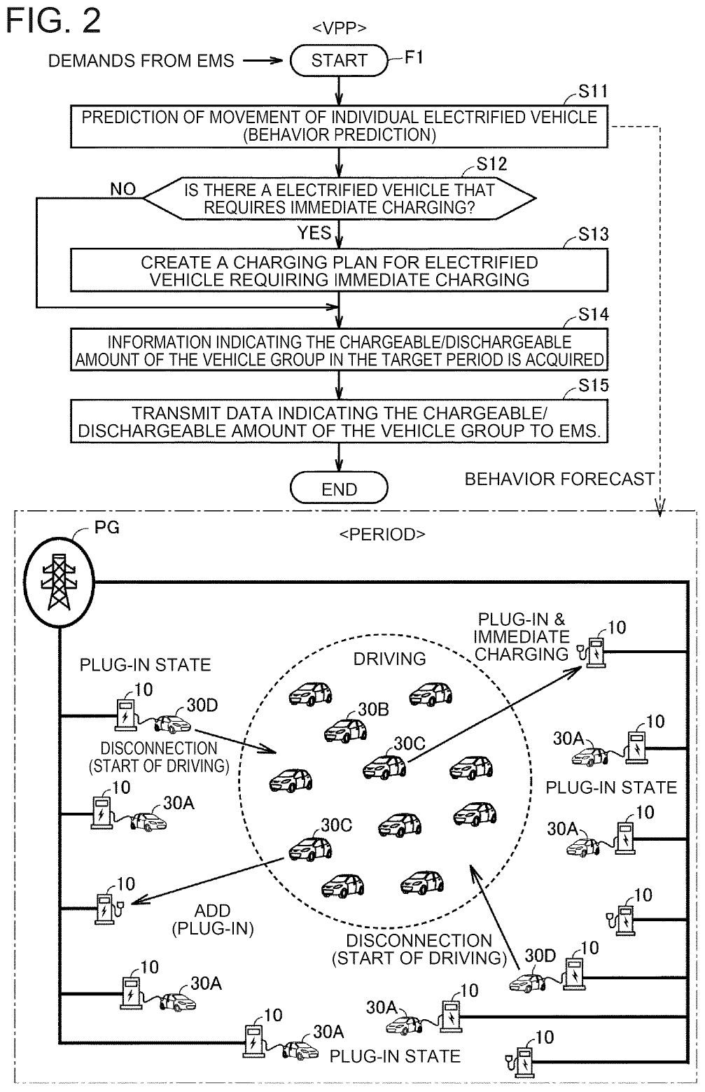

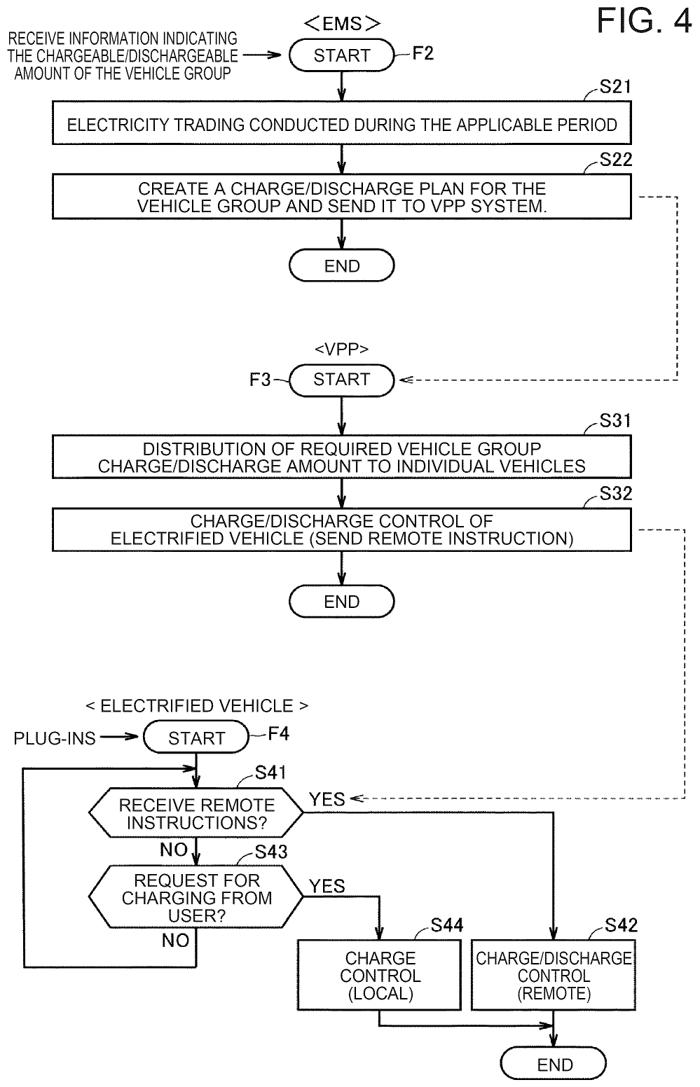

EMS 200 may be a City EMS (CEMS) or a Factory EMS (FEMS). EMS 200 includes a processor 201 and a storage device 202. EMS 200 is configured to be able to control directly or indirectly each of the plurality of power storage devices 20. VPP system 300 includes a processor 301 and a storage device 302. The storage device 302 stores information related to the respective electrified vehicle included in the vehicle group VG separately by the identification information (vehicle ID) for each individual vehicle (electrified vehicle 30). The storage device 302 stores in advance the specification information (for example, the storage capacity) of the power storage device 31 regarding the respective electrified vehicle included in the vehicle group VG. Further, each of the plurality of electrified vehicles 30 included in the vehicle group VG sequentially transmits the status (activation/deactivation) and the navigation-information of the vehicle system to VPP system 300. Each of the plurality of electrified vehicles 30 included in the vehicle group VG sequentially transmits the position and the status of the host vehicle (electrified vehicle 30) detected by the in-vehicle sensor to VPP system 300. The processor 301 updates the information in the storage device 302 using the information (location, SOC, charge reservation information, and the like) acquired from electrified vehicle 30 or the mobile terminal 50. In this embodiment, the one or more processors execute the programs stored in the one or more storage devices, thereby executing the respective controls illustrated in FIG. 2 and FIG. 4 described later. However, these processes may be executed by hardware (electronic circuit) alone, regardless of software. Each of VPP system 300 and EMS 200 corresponds to one of the “first management device” and the “second management device”.

EMS 200 is configured to communicate with each of the power marketplace system 100 and VPP system 300. EMS 200 transmits a signal (hereinafter, referred to as a “first request signal”) requesting the chargeable and dischargeable amount of the vehicle group VG in a predetermined future period (hereinafter, referred to as a “target period”) to VPP system 300. EMS 200 may transmit the first request-signal based on the power supply-demand forecast. When receiving the first request signal, VPP system 300 acquires information (hereinafter, referred to as “VPP information”) indicating the chargeable and dischargeable amount of the vehicle group VG in the target period. The chargeable and dischargeable amount includes at least one of an amount of electric power that the vehicle group VG can charge and an amount of electric power that the vehicle group VG can discharge. VPP system 300 transmits VPP data to EMS 200.

FIG. 2 is a flowchart illustrating a process of acquiring and transmitting VPP data by VPP system 300. Upon receipt of the above-described first request-signal, VPP system 300 starts the process flow F1 shown in the flow chart in FIG. 2. “S” in the flowchart means step. In S11, the processor 301 uses the information of each electrified vehicle stored in the storage device 302 to perform movement prediction (action prediction) for each electrified vehicle included in the vehicle group VG. The information of the respective electrified vehicle stored in the storage device 302 is, for example, position, SOC, and charge-reservation information. The processor 301 may predict the travel of electrified vehicle 30 using the travel schedule set for the navigation of electrified vehicle 30. The travel plan is, for example, a departure point, a departure time, a destination, an arrival time, a travel route to the destination, or the like. The processor 301 may predict electrified vehicle 30 travel schedule from historical data regarding electrified vehicle 30 travel (user behavior). The historical data is, for example, weather information, traffic congestion information, and historical location data that is managed separately by the day of the week. The processor 301 tracks the position of electrified vehicle 30 using the position data of electrified vehicle 30. At the same time, the processor 301 may predict the time of arrival of electrified vehicle 30 at the destination and the amount of stored electricity (SOC) at the time of arrival. The processor 301 may use the charge reservation data to predict a scheduled departure time of electrified vehicle 30.

In this embodiment, the processor 301 predicts the change in the amount of stored electricity as well as the change in the position of electrified vehicle 30 in S11. Further, the processor 301 predicts, for the respective electrified vehicle included in the vehicle group VG, the connection timing of electrified vehicle to the power system PG, the storage amount of electrified vehicle at the connection timing, and the detachment timing (for example, the scheduled departure time) of electrified vehicle to the power system PG after the connection timing. The connection timing is a timing at which electrified vehicle changes from the non-connected state to the connected state with respect to the power system PG. The detachment timing is a timing at which electrified vehicle is non-connected state from the power system PG after the connection timing. The processor 301 estimates electrified vehicle included in the vehicle group VG to be in the above-described state during the target period based on the estimation results. Specifically, the processor 301 classifies the respective electrified vehicle included in the vehicle group VG into an electrified vehicle 30A that is in the system connected state at all times in the target period, an electrified vehicle 30B that is in the system disconnection state at all times in the target period, an electrified vehicle 30C that changes from the system disconnection state to the system connected state within the target period, and an electrified vehicle 30D that changes from the system connected state to the system disconnection state within the target period. Hereinafter, electrified vehicle 30A that is connected state to the system at all times during the target period is also referred to as a “standby vehicle”. an electrified vehicle 30B that is constantly disconnected from the system during the target period is also referred to as a “traveling vehicle”. Electrified vehicle 30C that changes from the system disconnection state to the system connected state within the target period is also referred to as “connected vehicles”. an electrified vehicle 30D that changes from the system connected state to the system disconnected state within the target period is also referred to as a “disconnected vehicle”.

In a subsequent S12, the processor 301 determines whether there is any electrified vehicle 30 in the vehicle group VG that require immediate charging. Specifically, the processor 301 determines whether or not immediate charging is required for the respective electrified vehicle classified into the connected vehicles in S11. Immediate charging is an external charging in which electrified vehicle immediately starts using power from the power system PG when electrified vehicle is electrically connected to the power system PG. When electrified vehicle is electrically connected to the power system PG, electrified vehicle 30 changes from the disconnected state to the connected state. The processor 301 may determine whether immediate charging is required for electrified vehicle using the predicted connection timing and detachment timing. For example, the processor 301 may determine that immediate charging is required for an electrified vehicle in which the time from the connection timing to the detachment timing (hereinafter, referred to as “leaving time”) is shorter than a predetermined value. In addition, the processor 301 may increase the predetermined value as the amount of power storage at the connection timing predicted for electrified vehicle decreases. The shorter the start margin time, the higher the need for immediate charging. In addition, the smaller the amount of power storage at the connection timing, the higher the necessity of immediate charging tends to be. The processor 301 may determine that immediate charging is required, for example, for electrified vehicle that arrive (plug-in) at low SOC at night and depart a few hours later. For example, the processor 301 may determine that no immediate charging is required for an electrified vehicle that arrives (plug-ins) in a low SOC condition at night and remains in a grid connected state condition until the morning.

If it is determined that immediate charging is required for the at least one electrified vehicle 30 classified as connected vehicles, it is determined in S12 that it is YES, and the process proceeds to S13. Hereinafter, the connected vehicle determined to require immediate charging is referred to as an “immediate charging vehicle”. In addition, each of the connected vehicle, the leaving vehicle, and the standby vehicle determined not to require immediate charging is referred to as a “VPP vehicle”.

In S13, the processor 301 creates a charging plan for the immediate charging vehicles in the target time frame. The charging plan indicates the transition of the charging power of the power storage device 31. The processor 301 may calculate the starting time and the ending time of the immediate charging by using, for example, at least one of the storage amount (predicted value in S11) of the connection timing and the target SOC (charging reservation information) of the scheduled departure time for the immediate charging vehicle. Instead of the target SOC set by the user, a predetermined fixed value (for example, a SOC value near full charge) may be adopted. The charging plan of the immediate charging vehicle includes an amount of electric power required for immediate charging and a time period in which the immediate charging is performed. VPP system 300 may acquire specification information (for example, rated charging power) of an EVSE 10 to which the immediate charging vehicles are connected at the connection timing, and determine a time required for immediate charging based on the specification information. If there are more than one immediate charging vehicle in the vehicle group VG, the processor 301 creates a charging plan for each immediate charging vehicle. Then, when the charging plan is completed for all the immediate charging vehicles, the process proceeds to S14.

In S14, the processor 301 acquires VPP indicating the chargeable and dischargeable amount of the vehicle group VG in the target period by using the action forecast in S11 and the charging plan of the immediate charging vehicle created by S13. The processor 301 acquires VPP indicating the chargeable and dischargeable amount of the vehicle group VG on the assumption that the immediate charging vehicle performs the immediate charging. VPP includes a charging plan of the immediate charging vehicle. The processor 301 calculates the chargeable and dischargeable amount of the vehicle group VG based on the vehicle group capacity and the vehicle group power storage amount. The vehicle group capacity is the total amount of electric power that can be stored at the largest in all electrified vehicle electrically connected to the power system PG in the vehicle group VG. The vehicle group power storage amount is the total power amount stored in all electrified vehicle electrically connected to the power system PG in the vehicle group VG. In S14, information indicating the transition of each of the vehicle group capacity and the vehicle group power storage amount in the target period is acquired as VPP information. The processor 301 calculates the vehicle group power storage amount by taking into consideration the amount of change in the power storage amount of the immediate charging vehicle due to the immediate charging.

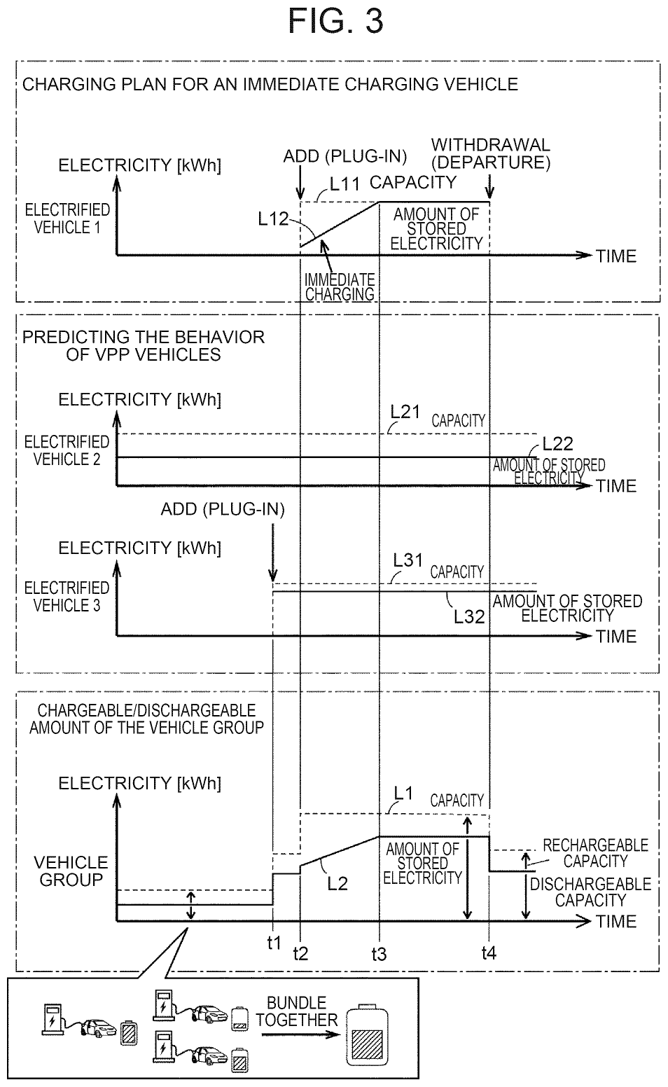

FIG. 3 is a diagram for explaining an exemplary VPP. In the vehicle group VG, the first to third electrified vehicles are electrically connected to the power system PG in at least a part of the target time interval. The first electrified vehicle, second electrified vehicle, and third electrified vehicle correspond to an immediate charging vehicle, a standby vehicle, and a connected vehicle determined not to require immediate charging, respectively. The time t1, t2 indicates the connection timing of the third electrified vehicle and the first electrified vehicle, respectively. The line L11, L21, L31 indicates the transition of the electric storage capacities (the electric power that can be stored at the largest) of the first, second and third electrified vehicle, respectively. The line L1 indicates the transition of the sum of the storage capacities of these electrified vehicle (vehicle group capacity). The line L12, L22, L32 indicates the transition of the amount of power storage (the amount of power held by the power storage device 31) when the first, second, and third electrified vehicle are electrically connected to the power system PG, respectively. The line L2 indicates the transition of the sum of the electric storage amounts of these electrified vehicle (vehicle group power storage amount).

Referring to FIG. 3, a line L12 shows a charging plan of the first electrified vehicle created in S13 of FIG. 2. The time t3 corresponds to the end-timing of the immediate charging calculated by S13. The charging plan of the first electrified vehicle is created so that the immediate charging starts at the time t2 and ends at the time t3. The time t4 after the time t3 corresponds to the detachment timing of the first electrified vehicle predicted by S11. Each of the lines L22, L32 indicates a transition of the electric storage amounts when the second and third electrified vehicle do not perform charging and discharging in the target period. The prediction information for each individual vehicle (the second electrified vehicle, the third electrified vehicle) is generated based on the result of the behavior prediction in S11 of FIG. 2.

The lines L1 and L2 indicate the transition of the chargeable and dischargeable amount of the vehicle group VG during the target period. A value obtained by subtracting the vehicle group power storage amount indicated by the line L2 from the vehicle group capacity (charging upper limit value) indicated by the line L1 corresponds to the electric power amount (chargeable amount) that can be charged by the vehicle group VG. The value obtained by subtracting the lower discharge limit value (e.g., 0 kWh) from the vehicle group power storage amount indicated by the line L2 corresponds to the electric power amount (dischargeable amount) that can be discharged by the vehicle group VG. In FIG. 3, the number of VPP vehicles is two, but the number of VPP vehicles is optional. The number of VPP vehicles may be 3 or more and less than 50, or 50 or more.

Referring back to FIG. 2, if it is determined that no immediate charging is required for all electrified vehicle 30 classified as connected vehicles, it is determined as NO in S12, and the process skips S13 and proceeds to S14. Again, at S14, the processor 301 obtains the aforementioned VPP using the outcome of S11 behavior forecast. However, since there is no electrified vehicle in the vehicle group VG that requires immediate charging, the immediate charging is not considered in the calculation of the vehicle group power storage amount.

Once S14 has acquired VPP information, VPP systems 300 transmit VPP information to S15 to EMS 200. At this time, in addition to VPP information, VPP system 300 may further transmit information indicating a transition of the chargeable/dischargeable maximum power (the maximum charge power and/or the maximum discharge power) of the vehicle group VG in the target period. VPP system 300 may acquire specification information (for example, rated power indicating charge/discharge capability) of EVSE 10 to which electrified vehicle is connected with respect to the respective VPP vehicles. VPP system 300 may determine the maximum chargeable/dischargeable power (kW) of electrified vehicle. When S15 process is executed, the process flow F1 ends.

FIG. 4 is a diagram for explaining the energy management according to the embodiment. Upon receiving VPP, EMS 200 starts the process flow F2.

Referring to FIG. 4, in S21, EMS 200 performs electric power trading based on the chargeable and dischargeable amount of the vehicle group VG (distributed power supply). Specifically, EMS 200 determines the bid amount in the target period using the chargeable and dischargeable amount of the vehicle group VG in the target period indicated by VPP information, and transmits the bid information including the bid amount to the power marketplace system 100. After that, when the commodity that EMS 200 has bid is awarded in the electric power marketplace, the contract is reached. In this case, the target period is the contract period, and the bid amount is the contract amount. The power market may be a spot market, a pre-hourly market, or a supply-and-demand coordination market, and may be opened and operated by a wholesale power exchange such as Japan Electric Power Exchange (JEPX). In each market, trading is performed using electric power as a commodity.

In a subsequent S22, EMS 200 requests energy management for the power system PG from VPP system 300 based on the outcome of the power transaction. Specifically, EMS 200 creates a charge/discharge plan of the vehicle group VG in order to cause the vehicle group VG to execute energy management (charge/discharge) corresponding to at least a part of the contract amount during the contract period (target period). EMS 200 creates a charge/discharge plan of the vehicle group VG so that the charge/discharge amount of the vehicle group VG in the target period does not exceed the chargeable and dischargeable amount. The charging/discharging plan indicates at least one of a transition of the charging power of the vehicle group VG and a transition of the discharging power of the vehicle group VG in the target period. Then, EMS 200 transmits a signal (hereinafter, referred to as a “second requesting signal”) including the created charge/discharge plan of the vehicle group VG to VPP system 300. The second request signal requests VPP system 300 to charge and discharge the vehicle group VG according to the charge and discharge plan. As a result, the process flow F2 ends.

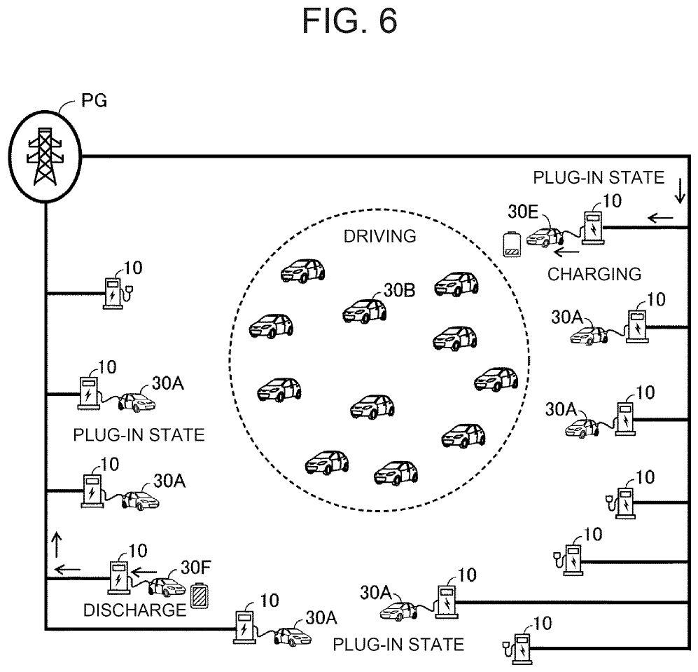

When VPP system 300 receives the second request-signal, it starts the process flow F3. In S31, VPP system 300 creates a charge/discharge plan for VPP vehicle (individual vehicle) by distributing a charge/discharge amount for executing the charge/discharge plan of the vehicle group VG indicated by the second request signal to a plurality of VPP vehicles (individual vehicles). The charge/discharging plan may be a charging plan or a discharging plan. VPP system 300 creates charge/discharge planning for each VPP vehicle so that charge by one VPP vehicle and discharge by another VPP vehicle are not executed simultaneously. As a result, power transfer between electrified vehicle (see FIG. 6), which will be described later, is suppressed. When the second request signal indicates the charging plan of the vehicle group VG, VPP system 300 may determine the charging plan for each VPP vehicle such that the earlier the scheduled departure time indicated by the charging reservation information is, the earlier the charging starting time is, with respect to the multiple VPP vehicles. This makes it easier for the user to perform the desired charging.

In the following S32, VPP system 300 transmits a charge/discharge instruction (remote instruction) to each corresponding electrified vehicle (immediate charging vehicle and VPP vehicle) so that the charging plan for the immediate charging vehicle created in S13 of FIG. 2 and the charging/discharging plan for each VPP vehicle (individual vehicle) created in S31 are each executed. However, when there is no immediate charging vehicle in the vehicle group VG, the charging plan of the immediate charging vehicle is not created in S13 of FIG. 2, and in S32, the charging/discharging instruction is transmitted only to VPP vehicle. VPP system 300 executes charge/discharge control (remote control) for each individual vehicle according to the above-described charge/discharge instruction (charge instruction and/or discharge instruction). When the charge/discharge control (S32) is completed, the process flow F3 ends.

ECU 35 of the respective electrified vehicle included in the vehicle group VG starts the process flow F4 when the corresponding electrified vehicle 30 changes from the system disconnection state to the system connected state. In S41, ECU 35 determines whether or not the corresponding electrified vehicle 30 (target vehicles) has received a charge/discharge instruction (S32) from VPP system 300. When the target vehicle receives the charging/discharging instruction (YES in S41), ECU 35 executes the charging/discharging control of the power storage device 31 in accordance with the charging/discharging instruction from VPP system 300 in S42. ECU 35 controls the charge/discharge circuit 32 in accordance with the charge/discharge instruction. When the target vehicle is a VPP vehicle, the charge/discharge planning assigned to VPP of the vehicles is executed by the target vehicle. As a result, the plurality of VPP vehicles execute the charge/discharge planning of EMS 200's vehicle group VG requested by VPP system 300. When the target vehicle is an immediate charging vehicle, the immediate charging is executed by the target vehicle. When the charge/discharge control (S42) is completed, the process flow F4 ends.

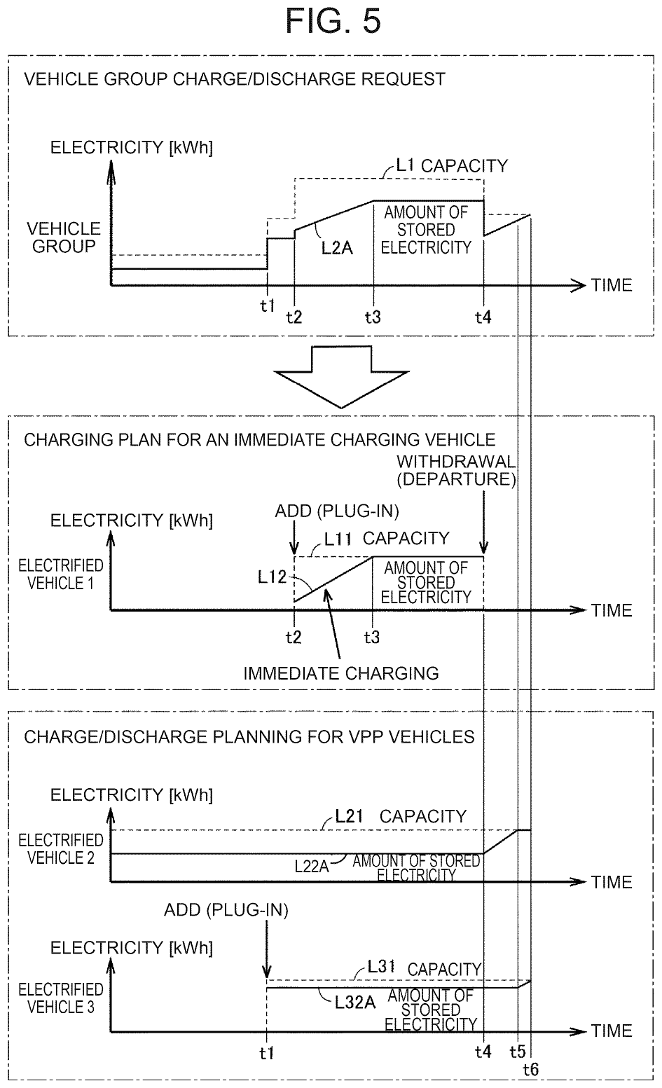

FIG. 5 is a diagram for explaining an example of the charge/discharge control (remote control). In FIG. 5, the same parameters as those shown in FIG. 3 are denoted by the same reference numerals. Referring to FIG. 5, in this example, as a charge/discharging plan of the vehicle group VG, a charging plan indicated by a line L2A is created and transmitted from EMS 200 to VPP system 300 (S22 of FIG. 4). EMS 200 uses VPP data received from VPP system 300 to create a charging plan (line L2A) indicating the transition of the charging power of the vehicle group VG in the target period so that the vehicle group power storage amount does not exceed the vehicle group capacity. VPP system 300 uses the charging plan received from EMS 200 to control the vehicle group VG. Specifically, the charging planning indicated by the line L2A requires VPP system 300 to charge from the time t4 to the time t6. VPP system 300 creates a charging plan for each of second electrified vehicle and third electrified vehicle such that the charge required from the charging plan is performed. For example, VPP system 300 creates a first vehicle charging plan that causes the second electrified vehicle to perform charging during a time period from the time t4 to the time t5 as indicated by the line L22A. Further, VPP system 300 creates a second vehicle charging plan that causes the third electrified vehicle to perform charging during a time period from the time t5 to the time t6 as indicated by the line L32A, for example. Then, by the process of S32 and S42 in FIG. 4, the charge/discharge control (remote control) is executed for each individual vehicle in accordance with the immediate charging plan for causing the first electrified vehicle to perform the charge in the time period from the time t2 to the time t3 as indicated by the line L12, the first vehicle charging plan indicated by the line L22A, and the second-vehicle charging plan indicated by the line L32A.

Referring back to FIG. 4, if the target vehicle does not receive the charge/discharge instruction (NO in S41), ECU 35 determines whether or not a charge request has been received from the user in S43. The user may request ECU 35 to charge, for example, through the mobile terminal 50 or HMI 38. When a charging request is received from the user (YES in S43), ECU 35 controls the charge/discharge circuit 32 so that the external charging is executed in S44 until SOC of the power storage device 31 reaches a predetermined SOC. The predetermined SOC value may be set by the user or may be a fixed value. ECU 35 performs charge control (local control) of the power storage device 31 regardless of an instruction from the outside. When the charge control (S44) is completed, the process flow F4 ends.

If both of S41, S43 are determined to be NO, the process returns to the first step (S41). The determination of S41, S43 is repeated until it is determined that it is YES in any of S41, S43. However, the process flow F4 ends when the target vehicle is disconnected from the system.

As described above, even if S41 determines that the vehicle is NO when the target vehicle changes from the system disconnection state to the system connected state, the user requests ECU 35 to charge the vehicle, so that the vehicle is determined to be YES by S43, and the immediate charging is executed. The user can perform immediate charging at his own discretion. However, if the immediate charging is executed according to an instruction from the user during the target time period, there is a possibility that a deviation occurs between the chargeable and dischargeable amount of the vehicle group VG indicated by VPP data and the chargeable and dischargeable amount of the actual vehicle group VG.

Therefore, in VPP system 300 according to this embodiment, there may be an electrified vehicle in the vehicle group VG that needs immediate charging. In this case, it is configured to acquire VPP information (see FIG. 3) indicating the chargeable and dischargeable amount of the vehicle group VG on the assumption that electrified vehicle (immediate charging vehicle) performs immediate charging, and transmit the acquired VPP information to EMS 200 (see FIG. 2). This reduces the likelihood that the charge (in particular, immediate charging) that VPP system 300 did not predict after VPP system 300 sent VPP to EMS 200 will be performed. EMS 200 can plan the charging and discharging of the vehicle group VG considering the amount of electric power caused by the immediate charging vehicles. EMS 200 does not handle information on individual vehicles, but only information on the vehicle group VG. Thus, the load (for example, the calculation load) of the information processing in EMS 200 is reduced.

Further, VPP system 300 causes the immediate charging vehicles to perform immediate charging by remote control (see FIG. 4). That is, in electrified vehicle where immediate charging is required in the target period, immediate charging is executed by remote control. Therefore, it is unlikely that the immediate charging is executed according to an instruction from the user in the target period. Therefore, the occurrence of the above-described deviation is suppressed.

In some cases, a deviation occurs between the chargeable and dischargeable amount of the vehicle group VG indicated by VPP data and the chargeable and dischargeable amount of the actual vehicle group VG during the target period. In this case, VPP system 300 may cancel out the deviation by the transfer of electric power between electrified vehicle included in the vehicle group VG. FIG. 6 is a diagram for explaining power transfer between electrified vehicle included in the vehicle group VG.

Referring to FIG. 6, VPP system 300 may be in a grid connected state with each of the low SOC state electrified vehicle 30E and the high SOC state electrified vehicle 30F. In this electrified vehicle 30F, the external power supply (discharging to the power system PG) of the predetermined amount of electric power may be executed in a large amount of electric power storage, and the external charge of the predetermined amount of electric power may be executed in an electrified vehicle 30E where the amount of electric power storage is small. As a result, the predetermined amount of electric power is exchanged between electrified vehicle 30E, 30F. Power is exchanged through the power system PG. However, in the power exchange between electrified vehicles, a loss occurs along with charging/discharging. In order to reduce the loss, it is preferable to eliminate the need for power transfer between electrified vehicle. That is, it is desirable to reduce the likelihood that the charge that VPP system 300 did not predict will be performed after VPP system 300 transmits VPP (S15 of FIG. 2).

The processing flows shown in FIG. 2 and FIG. 4 can be changed as appropriate. For example, the order of processing may be changed, or unnecessary steps may be omitted, depending on the purpose. Further, the content of any of the processes may be changed. For example, VPP system 300 may separately transmit, at S15, information indicating a transition of each of the storage capacity and the storage amount with respect to the immediate charging vehicle and information indicating a transition of each of the storage capacity and the storage amount with respect to VPP vehicle to EMS 200. Further, in S43 of the process flow F4 (FIG. 4), ECU 35 may determine whether the user is requesting charging based on the charging reservation data. In addition, VPP system 300 may transmit the charge/discharge instruction to only VPP vehicle in S32 of process flow F3 (FIG. 4) when an immediate charging vehicle is present in the vehicle group VG. With regard to the immediate charging vehicle, it is predicted that immediate charging will be required, and even if VPP system 300 does not instruct the immediate charging vehicle to charge, it is highly likely that immediate charging (local control) will be executed according to a request from the user.

The power system PG is not limited to a large-scale AC grid, and may be a microgrid or a direct current (DC) grid. The mobile terminal 50 is not limited to a smartphone, and may be another terminal (a wearable device, a portable game machine, or the like).

The configuration of electrified vehicle is not limited to the above-described configuration (see FIG. 1). In the above-described embodiment, electrified vehicle included in the vehicle group VG are configured to be capable of discharging the power of the power storage device 31 to the power system PG. However, such a configuration is not essential, and electrified vehicle may include a charger (charging circuitry) instead of the charger/discharger. The power converter for charging and discharging the in-vehicle battery may be mounted on EVSE instead of electrified vehicle. Electrified vehicle may be configured to be contactless chargeable. Electrified vehicle for performing the contactless charge may be regarded as being in a state corresponding to the aforementioned “system connected state” when the alignment between the power transmission unit (for example, the power transmission coil) on the power supply facility side and the power reception unit (for example, the power reception coil) on electrified vehicle side is completed. Electrified vehicle may be configured to be capable of autonomous driving. Electrified vehicle is not limited to a four-wheel passenger car, and may be a bus or a truck, and any number of wheels may be used.

Various modifications described above may be implemented in any combination.

The embodiment disclosed herein should be considered as illustrative and not restrictive in all respects. The scope of the present disclosure is shown by the claims rather than the above embodiment, and is intended to include all modifications within the meaning and the scope equivalent to those of the claims.

What is claimed is:

1. A management system comprising a first management device that manages a vehicle group including a plurality of electrified vehicles and a second management device that requests energy management related to a power system to the first management device, wherein:
each of the electrified vehicles included in the vehicle group comprises a power storage device and is configured to enable the power storage device to be charged by power from the power system;
the first management device determines whether or not there is an electrified vehicle present within the vehicle group that requires immediate charging, when determination is made that there is an electrified vehicle present within the vehicle group that requires immediate charging, on an assumption that the electrified vehicle performs immediate charging, the first management device is configured to acquire information that shows a chargeable and dischargeable amount including at least one of a power amount that enables the vehicle group to be charged and a power amount that enables the vehicle group to be discharged, and transmit information that shows the acquired chargeable and dischargeable amount to the second management device; and
the immediate charging is charging that, when any one of the electrified vehicles included in the vehicle group is electrically connected to the power system, the electrified vehicle immediately starts by using power from the power system.

2. The management system according to claim 1, wherein:
for each of the electrified vehicles included in the vehicle group, the first management device is configured to predict a connection timing and a detachment timing, the connection timing being a timing at which each of the electrified vehicles changes from a non-connected state to a connected state with respect to the power system, and the detachment timing being a timing at which each of the electrified vehicles is in the non-connected state with respect to the power system after the connection timing; and
the first management device is configured to determine whether there is an electrified vehicle present within the vehicle group that requires immediate charging by using the predicted connection timing and the predicted detachment timing.

3. The management system according to claim 2, wherein for each of the electrified vehicles included in the vehicle group, the first management device is configured to further predict a power storage amount of the electrified vehicle at the connection timing, and determine whether there is an electrified vehicle present within the vehicle group that requires immediate charging by further using the predicted storage amount.

4. The management system according to claim 1, wherein:
the first management device is configured to acquire information that shows a transition of each of a vehicle group capacity and a vehicle group power storage amount as information that shows a chargeable and dischargeable amount, the vehicle group capacity being a total power amount capable of being stored at a maximum by all electrified vehicles electrically connected to the power system within the vehicle group in a prescribed time period, and the vehicle group power storage amount being a total power amount all of the electrified vehicles electrically connected to the power system within the vehicle group; and
for an electrified vehicle that requires immediate charging in the prescribed time period, the first management device is configured to calculate the vehicle group power storage amount by taking into consideration an amount of change of a power storage amount of the electrified vehicle by the immediate charging.

5. The management system according to claim 4, wherein:
the second management device is configured to create a charging plan that shows a transition of charging power of the vehicle group in the prescribed time period, so the vehicle group power storage amount does not exceed the vehicle group capacity, by using information that shows the chargeable and dischargeable amount received from the first management device, and transmit the created charging plan to the first management device; and the first management device is configured to control the vehicle group by using the charging plan received from the second management device.
